(19) United States
(12) Patent Application Publication
(10) Pub. No.: US 2024/0156167 A1
(43) Pub. Date: May 16, 2024

(54) AEROSOL GENERATION APPARATUS AND POWER SUPPLY APPARATUS THEREOF

(71) Applicant: VERDEWELL INTERNATIONAL HOLDINGS LIMITED, George Town (KY)

(72) Inventor: Feng CHEN, Shenzhen (CN)

(21) Appl. No.: 18/500,298

(22) Filed: Nov. 2, 2023

(30) Foreign Application Priority Data
Nov. 11, 2022 (CN) 202223021332.7

(51) Int. Cl. A24F 40/485; A24F 40/60; F16K 21/00

(52) U.S. Cl. CPC A24F 40/485; A24F 40/60; F16K 21/00

(57) ABSTRACT

A power supply apparatus for an aerosol generation apparatus having a vaporizer, the power supply apparatus including: a housing having a first end and a second end opposite the first end, an accommodating portion for accommodating the vaporizer being formed in the housing, the accommodating portion including a side wall and running through from the first end to the second end, the vaporizer being mounted in the accommodating portion; and a regulating valve for adjusting an air inflow, the regulating valve having an elongated toggle member extending along a direction parallel to an axis of the vaporizer.

### CROSS-REFERENCE TO PRIOR APPLICATION

Priority is claimed to Chinese Patent Application No. 202223021332.7, filed on Nov. 11, 2022, the entire disclosure of which is hereby incorporated by reference herein.

### FIELD

The present application relates to the field of aerosol generation technologies, and in particular, to an aerosol generation apparatus and a power supply apparatus thereof.

### BACKGROUND

The aerosol generation apparatus in the related technology is provided with an airflow adjustment structure for adjusting an air inflow. The aerosol generation apparatus includes a vaporization housing, a vaporization core arranged in the vaporization housing, and a regulating valve. The vaporization core is provided with an airflow channel. The regulating valve is mounted on an airflow channel. The regulating valve and the vaporization housing are coaxially arranged. During use, a user needs to hold the vaporization housing with one hand and use at least two fingers of the other hand to clamp the regulating valve to rotate for adjustment. Such an airflow adjustment structure requires the user to operate with both hands in use to adjust the air inflow, and consequently, the operation is troublesome, making it inconvenient and uncomfortable for the user to use.

### SUMMARY

In an embodiment, the present invention provides a power supply apparatus for an aerosol generation apparatus comprising a vaporizer, the power supply apparatus comprising: a housing having a first end and a second end opposite the first end, an accommodating portion configured to accommodate the vaporizer being formed in the housing, the accommodating portion comprising a side wall and running through from the first end to the second end, the vaporizer being mounted in the accommodating portion; and a regulating valve configured to adjust an air inflow, the regulating valve comprising an elongated toggle member extending along a direction parallel to an axis of the vaporizer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an embodiment of an aerosol generation apparatus according to the present application;

FIG. 2 is a sectional view of an embodiment of the aerosol generation apparatus according to the present application;

FIG. 3 is an assembly diagram of a thread sleeve and a regulating valve according to the present application; and

FIG. 4 is an exploded view of the embodiment shown in FIG. 3.

### DETAILED DESCRIPTION

In an embodiment, the present invention provides an improved aerosol generation apparatus and a power supply apparatus thereof.

In an embodiment, the present invention describes constructing to a power supply apparatus, applied to an aerosol generation apparatus. The aerosol generation apparatus includes a vaporizer. The power supply apparatus includes:
a housing having a first end and a second end opposite to the first end, where an accommodating portion for accommodating the vaporizer is formed in the housing, the accommodating portion includes a side wall and runs through from the first end to the second end, and the vaporizer is mounted in the accommodating portion; and
a regulating valve for adjusting an air inflow, where the regulating valve includes an elongated toggle member, and the toggle member extends along a direction parallel to an axis of the vaporizer.

In some embodiments, the regulating valve is rotatable back and forth between a first position and a second position to adjust the magnitude of the air inflow.

In some embodiments, the air inflow of the regulating valve gradually decreases when the regulating valve rotates from the first position to the second position.

In some embodiments, the regulating valve includes a cylindrical body, the cylindrical body is provided with a first air inlet, and the first air inlet extends along the circumference of the cylindrical body and is in air communication with the outside.

In some embodiments, the side wall is provided with an opening, and the regulating valve is arranged corresponding to the opening.

In some embodiments, the housing further includes a mounting portion arranged side by side with the accommodating portion; and the mounting portion runs through from the first end to the second end.

In some embodiments, the first end is provided with a switch component, and the switch component is arranged in the mounting portion.

In some embodiments, the power supply apparatus further includes an elastic pin assembly, and the elastic pin assembly is arranged in the accommodating portion and electrically connected the vaporizer.

The present application further constructs an aerosol generation apparatus, including:
a vaporizer, including an exposed suction nozzle, where an air inlet channel in air communication with the outside is formed in the vaporizer; and
a power supply apparatus, including: a housing having a first end and a second end opposite to the first end, where an accommodating portion for accommodating the vaporizer is formed in the housing, the accommodating portion includes a side wall and runs through from the first end to the second end, and the vaporizer is mounted in the accommodating portion; and a regulating valve for adjusting an air inflow, where the regulating valve includes an elongated toggle member, and the toggle member extends along a direction parallel to an axis of the vaporizer.

In some embodiments, the aerosol generation apparatus further includes a thread sleeve, where the thread sleeve is arranged in the accommodating portion, screwed to one end of the vaporizer away from the suction nozzle, and removably connected to the power supply apparatus; and
the regulating valve is connected to the thread sleeve, communicates with the air inlet channel through the thread sleeve, and is rotatable around the thread sleeve.

In some embodiments, the regulating valve includes a cylindrical body, the cylindrical body is provided with a first air inlet, the first air inlet communicates with the outside and the air inlet channel, the regulating valve is sleeved over the thread sleeve, the thread sleeve is provided with a second air inlet matching the first air inlet, and the second air inlet is in air communication with the first air inlet.

In some embodiments, the second air inlet is provided directly facing the first air inlet.

In some embodiments, an aperture of the second air inlet is greater than or equal to an aperture of the first air inlet.

In some embodiments, the aerosol generation apparatus further includes a bracket, the bracket is mounted in the housing, and the thread sleeve and the power supply apparatus are mounted on the bracket.

In some embodiments, the power supply apparatus further includes at least one sealing ring, and the at least one sealing ring is sleeved over the thread sleeve and abuts against the regulating valve.

In some embodiments, the at least one a sealing ring includes two sealing rings, and the two sealing rings are provided respectively on upper and lower sides of the second air inlet in an axial direction.

In some embodiments, the thread sleeve is cylindrical and includes a first cylinder section connected to the vaporizer and a second cylinder section connected to the first cylinder section, the first cylinder section is provided with internal threads screwed to the vaporizer, and the second cylinder section extends along one end of the first cylinder section away from the vaporizer.

In some embodiments, the regulating valve is sleeved over the second cylinder section, and the second air inlet is provided in the second cylinder section.

Through implementation of the application, the following beneficial effects are achieved: The power supply apparatus of the present application includes the regulating valve for adjusting the air inflow. The regulating valve of the present application includes the elongated toggle member, the toggle member extends along the direction parallel to the axis of the vaporizer, and the air inflow can be adjusted by rotating the regulating valve. The regulating valve is easy to operate and can be operated with one hand to adjust the air inflow, so that different suction resistances can be achieved and requirements of users with different habits can be met.

In order to have a clearer understanding of the technical features, objectives, and effects of the present application, specific implementations of the present application are now illustrated in detail with reference to the accompanying drawings. In the following description, it should be understood that orientation or position relationships indicated by terms such as “front”, “rear”, “upper”, “lower”, “left”, “right”, “longitudinal”, “transverse”, “vertical”, “horizontal”, “top”, “bottom”, “inner”, “outer”, “head”, and “tail” are based on orientation or position relationships shown in the accompanying drawings, constructed and operated in specific orientations, and are intended only to facilitate the description of the technical solution, rather than indicating that the mentioned apparatus or component must have the specific orientations. Therefore, such terms should not be construed as a limitation to the application.

It should also be noted that, unless otherwise explicitly specified and limited, terms such as “mount”, “connect”, “connection”, “fix”, and “arrange” should be interpreted in a broad sense. For example, a connection may be a fixed connection, a detachable connection, or an integral connection; or the connection may be a mechanical connection or an electrical connection; or the connection may be a direct connection, an indirect connection through an intermediate medium, internal communication between two components, or an interaction relationship between two components. When a component is referred to as being “on” or “under” another component, it can be “directly” or “indirectly” on the other component, or one or more intervening components may also be present. Terms such as “first”, “second”, and “third” are used merely for the purpose of description, and shall not be construed as indicating or implying relative importance or implying a quantity of indicated technical features. Therefore, a feature restricted by “first”, “second”, “third”, or the like may explicitly indicate or implicitly include one or more such features. A person of ordinary skill in the art can understand specific meanings of the terms in the present application according to specific situations.

In the following description, for the purpose of illustration rather than limitation, specific details such as specific system structures and techniques are proposed to provide a thorough understanding of the embodiments of the present application. However, it should be clear to a person skilled in the art that the present application can still be implemented in other embodiments without these specific details. In other cases, detailed descriptions of well-known systems, apparatuses, circuits, and methods are omitted so that unnecessary details do not obscure the description of the present application.

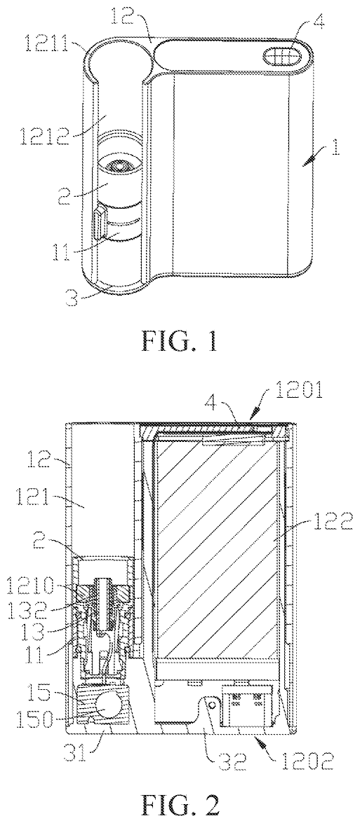

FIG. 1 shows an aerosol generation apparatus of an embodiment of the present application. The aerosol generation apparatus includes a vaporizer, a power supply apparatus 1, and a thread sleeve 2. The vaporizer is connected to the power supply apparatus 1 and powered by the power supply apparatus 1. The vaporizer includes an exposed suction nozzle. An air inlet channel in air communication with the outside is formed in the vaporizer. The outside air enters the vaporizer through the air inlet channel, and is discharged through the suction nozzle along with aerosol produced by the vaporizer. The power supply apparatus 1 includes an accommodating portion 121 for accommodating the vaporizer and a regulating valve 11 for adjusting an air inflow. The vaporizer may be mounted in the accommodating portion 121. The thread sleeve 2 is arranged in the accommodating portion 121. The thread sleeve 2 is screwed to one end of the vaporizer away from the suction nozzle and removably connected to the power supply apparatus 1. In some embodiments, the vaporizer is rotatably arranged in the accommodating portion 121, and the thread sleeve 2 enables the vaporizer and the power supply apparatus 1 to rotate with respect to each other, so that a direction of the suction nozzle of the vaporizer can be adjusted. The regulating valve 11 is connected to the thread sleeve 2. The regulating valve 11, the thread sleeve 2, and the air inlet channel are in air communication with one another, and the regulating valve 11 is rotatable around the thread sleeve 2, to adjust the air inflow.

In some embodiments, the thread sleeve 2 is roughly cylindrical and provided with internal threads screwed to the vaporizer.

The thread sleeve 2 has a mounting opening for mounting the vaporizer. The end of the vaporizer away from the suction nozzle is mounted in the mounting opening.

Referring to both FIG. 2 and FIG. 4, in some embodiments, the vaporizer is magnetically connected to the power supply apparatus 1 through the thread sleeve 2. The accommodating portion 121 is provided with a magnetic member 1210, and the thread sleeve 2 and the magnetic member 1210 may be magnetically attracted, to allow the vaporizer to be electrically connected to the power supply apparatus 1. In some embodiments, the magnetic member 1210 may be a magnet, and the thread sleeve 2 may be made of a ferromagnetic material. The vaporizer is attractively connected to the power supply apparatus 1 through the thread sleeve 2, which is fast and convenient. In addition, the thread sleeve 2 is made of a ferromagnetic material, which is convenient to process and low in costs. In some other embodiments, the magnetic member 1210 may be made of a ferromagnetic material, and the thread sleeve 2 may be a magnet.

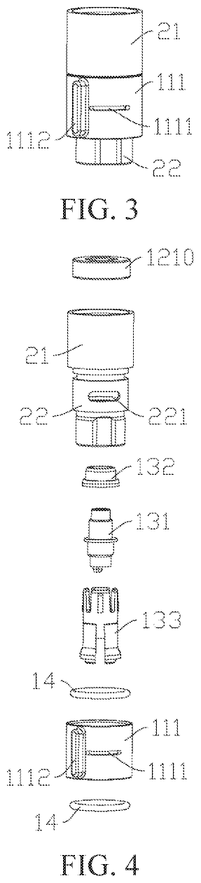

As shown in FIG. 3 and FIG. 4, in some embodiments, the thread sleeve 2 includes a first cylinder section 21 connected to the vaporizer and a second cylinder section 22 connected to the first cylinder section 21. The first cylinder section 21 is provided with internal threads screwed to the vaporizer. The second cylinder section 22 extends along one end of the first cylinder section 21 away from the vaporizer. In some embodiments, a diameter of the first cylinder section 21 may be greater than a diameter of the second cylinder section 22.

With reference to FIG. 1 and FIG. 2, in some embodiments, the power supply apparatus 1 includes a housing 12 having a first end 1201 and a second end 1202 opposite to the first end 1201. The accommodating portion 121 is formed in the housing 12. The vaporizer may be mounted in the accommodating portion 121. The housing 12 further includes a mounting portion 122 arranged side by side with the accommodating portion 121. The accommodating portion 121 may be roughly cylindrical, for accommodating the vaporizer, the thread sleeve 2, the regulating valve 11, and other electronic components. The vaporizer may be mounted into the accommodating portion 121 from the first end 1201 of the housing 12, and screwed to the thread sleeve 2. In this case, the suction nozzle protrudes from the first end 1201 of the housing 12.

As shown in FIG. 1, in some embodiments, the accommodating portion 121 includes a side wall 1211, and runs through from the first end 1201 of the housing 12 to the second end 1202 of the housing 12. In some embodiments, the side wall 1211 is provided with an opening 1212, and the regulating valve 11 is arranged corresponding to the opening 1212, so that the air inflow can be adjusted through the regulating valve 11. The mounting portion 122 may be in a shape of a flat cylinder and used for accommodating electronic components such as a battery core and a main control board in the power supply apparatus 1. In some embodiments, the mounting portion 122 runs through from the first end 1201 of the housing 12 to the second end 1202 of the housing 12. The first end 1201 of the housing 12 is provided with a switch component 4, and the switch component 4 is arranged in the mounting portion 122. The switch can be used for controlling on or off of the aerosol generation apparatus.

In some embodiments, the aerosol generation apparatus further includes a bracket 3, the bracket 3 is mounted in the housing 12, and the thread sleeve 2 and the power supply apparatus 1 are mounted on the bracket 3. In some embodiments, the bracket 3 may be mounted into the housing 12 from the second end 1202 of the housing 12.

As shown in FIG. 2, in some embodiments, the bracket 3 includes a first support portion 31 and a second support portion 32. The thread sleeve 2 is mounted on the first support portion 31, and the first support portion 31 is mounted in the accommodating portion 121.

The second support portion 32 is mounted in the mounting portion 122, and can be fixed to the switch component 4 by a bolt to limit axial movement of the bracket 3.

In some embodiments, the aerosol generation apparatus further includes microphone silicone 15. The microphone silicone 15 is arranged in the first support portion 31, for sealing a microphone 150.

As shown in FIG. 4, in some embodiments, the power supply apparatus 1 further includes an elastic pin assembly 13. The elastic pin assembly 13 is arranged in the accommodating portion 121 and can be electrically connected to the vaporizer. The elastic pin assembly 13 includes an elastic pin 131. The elastic pin 131 is inserted in the magnetic member 1210, and the elastic pin 131 is insulated from the magnetic member 1210.

When the vaporizer is mounted in the mounting opening of the thread sleeve 2, a conductive head of the vaporizer is electrically connected to the elastic pin 131.

In some embodiments, the elastic pin assembly 13 further includes elastic pin silicone 132. The elastic pin silicone 132 is ringed outside the elastic pin 131, and located between the elastic pin 131 and the magnetic member 1210, for insulation and sealing between the elastic pin 131 and the magnetic member 1210.

In some embodiments, the elastic pin assembly 13 further includes an elastic pin support member 133. The elastic pin 131 may be mounted on one end of the elastic pin support member 133 close to the first end 1201 of the housing 12. The elastic pin support member 133 may be arranged in the thread sleeve 2, and has a gap with an inner wall of the thread sleeve 2. The elastic pin support member 133 is provided with a flange on one end thereof close to the second end 1202 of the housing 12. The flange may abut against one end of the thread sleeve 2 close to the second end 1202 of the housing 12, to limit downward displacement thereof.

As shown in FIG. 3 and FIG. 4, in some embodiments, the regulating valve 11 is sleeved over the thread sleeve 2 and is rotatable back and forth around the thread sleeve 2 between a first position and a second position. When the regulating valve 11 is located at the first position, the air inflow of the regulating valve is the largest. When the regulating valve 11 located at the second position, the air inflow of the regulating valve is the smallest. In some embodiments, the regulating valve 11 rotates around the thread sleeve 2 along a direction from the first position to the second position, the air inflow of the regulating valve 11 gradually decreases.

In some embodiments, the regulating valve 11 includes a cylindrical body 111. The cylindrical body 111 is provided with a first air inlet 1111. The first air inlet 1111 communicates with the outside and the air inlet channel. The regulating valve 11 is sleeved over the thread sleeve 2. The thread sleeve 2 is provided with a second air inlet 221 matching the first air inlet 1111. The second air inlet 221 is in air communication with the first air inlet 1111.

In some embodiments, the second air inlet 221 is provided directly facing the first air inlet 1111.

In some embodiments, an aperture of the second air inlet 221 is greater than or equal to an aperture of the first air inlet 1111, to ensure that air entering from the first air inlet 1111 can enter the air inlet channel through the second air inlet 221. The shape of the second air inlet 221 may be the same as that of the first air inlet 1111.

As shown in FIG. 3, in some embodiments, the regulating valve 11 may be sleeved over the second cylinder section 22 of the thread sleeve 2, and the second air inlet 221 is provided in the second cylinder section 22 and corresponds to the first air inlet 1111 in the thread sleeve 2.

When air enters the first air inlet 1111, the air can enter the air inlet channel in the vaporizer through the second air inlet 221. The regulating valve 11 is rotatable around the thread sleeve 2. When the regulating valve 11 is rotated, the first air inlet 1111 and the second air inlet 221 are staggered, resulting in a smaller actual air inlet area. A larger staggered area indicates a smaller air inlet area. In this way, when a user uses the vaporizer for inhalation, the corresponding inhalation resistance increases accordingly, thereby achieving the objective of adjusting the inhalation resistance, so that requirements of users with different habits can be met.

As shown in FIG. 3 and FIG. 4, in some embodiments, the regulating valve 11 further includes a toggle member 1112 arranged on the cylindrical body 111. The toggle member 1112 is elongated and extends along a direction parallel to an axis of the vaporizer, to facilitate an operation by a user. When the user holds the power supply apparatus 1 or uses the aerosol generation apparatus, it is convenient for the user to user a finger to toggle the toggle member 1112 to adjust the air inflow, so that the aerosol generation apparatus can be held with one hand and the air inflow can be adjusted by toggling the regulating valve with one finger, thereby achieving a one-handed operation to adjust the air inflow.

As shown in FIG. 4, in some embodiments, the power supply apparatus 1 further includes at least one sealing ring 14. The sealing ring 14 is sleeved over the thread sleeve 2 and abuts against the regulating valve 11. The regulating valve 11 is assembled with the thread sleeve 2 and engaged with the sealing ring 14. The sealing ring 14 is used for supporting and sealing the regulating valve 11.

In some embodiments, two sealing rings 14 may be provided. The two sealing rings 14 are provided respectively on upper and lower sides of the first air inlet 1111 in an axial direction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A power supply apparatus for an aerosol generation apparatus comprising a vaporizer, the power supply apparatus comprising:
a housing having a first end and a second end opposite the first end, an accommodating portion configured to accommodate the vaporizer being formed in the housing, the accommodating portion comprising a side wall and running through from the first end to the second end, the vaporizer being mounted in the accommodating portion; and
a regulating valve configured to adjust an air inflow, the regulating valve comprising an elongated toggle member extending along a direction parallel to an axis of the vaporizer.

2. The power supply apparatus of claim 1, wherein the regulating valve is rotatable between a first position and a second position to adjust a magnitude of the air inflow.

3. The power supply apparatus of claim 2, wherein the regulating valve is configured to gradually decrease the air inflow when the regulating valve rotates from the first position to the second position.

4. The power supply apparatus of claim 1, wherein the regulating valve comprises a cylindrical body having a first air inlet that extends along a circumference of the cylindrical body and is in air communication with an outside.

5. The power supply apparatus of claim 1, wherein the side wall is provided with an opening, and
wherein the regulating valve is arranged corresponding to the opening.

6. The power supply apparatus of claim 1, wherein the housing comprises a mounting portion arranged side by side with the accommodating portion, and
wherein the mounting portion runs through from the first end to the second end.

7. The power supply apparatus of claim 6, wherein the first end is provided with a switch component, and
wherein the switch component is arranged in the mounting portion.

8. The power supply apparatus of claim 1, further comprising:
an elastic pin assembly arranged in the accommodating portion and electrically connected the vaporizer.

9. An aerosol generation apparatus, comprising:
a vaporizer comprising an exposed suction nozzle, an air inlet channel in air communication with an outside being formed in the vaporizer; and
a power supply apparatus comprising a housing having a first end and a second end opposite the first end, an accommodating portion configured to accommodate the vaporizer being formed in the housing, the accommodating portion comprising a side wall and running through from the first end to the second end, the vaporizer being mounted in the accommodating portion; and
a regulating valve configured to adjust an air inflow, the regulating valve comprising an elongated toggle member extending along a direction parallel to an axis of the vaporizer.

10. The aerosol generation apparatus of claim 9, further comprising:
a thread sleeve arranged in the accommodating portion, the thread sleeve being screwed to one end of the vaporizer away from the suction nozzle, and removably connected to the power supply apparatus,
wherein the regulating valve is connected to the thread sleeve, is configured to communicate with the air inlet channel through the thread sleeve, and is rotatable around the thread sleeve.

11. The aerosol generation apparatus of claim 10, wherein the regulating valve comprises a cylindrical body provided with a first air inlet configured to communicate with the outside and the air inlet channel,
wherein the regulating valve is sleeved over the thread sleeve,
wherein the thread sleeve is provided with a second air inlet matching the first air inlet, and
wherein the second air inlet is in air communication with the first air inlet.

12. The aerosol generation apparatus of claim 11, wherein the second air inlet is provided directly facing the first air inlet.

13. The aerosol generation apparatus of claim 11, wherein an aperture of the second air inlet is greater than or equal to an aperture of the first air inlet.

14. The aerosol generation apparatus of claim 10, further comprising:
a bracket mounted in the housing,
wherein the thread sleeve and the power supply apparatus are mounted on the bracket.

15. The aerosol generation apparatus of claim 11, wherein the power supply apparatus further comprises at least one sealing ring sleeved over the thread sleeve and that abuts against the regulating valve.

16. The aerosol generation apparatus of claim 15, wherein the at least one a sealing ring comprises two sealing rings, and
wherein the two sealing rings are provided respectively on upper and lower sides of the second air inlet in an axial direction.

17. The aerosol generation apparatus of claim 11, wherein the thread sleeve is cylindrical and comprises a first cylinder section connected to the vaporizer and a second cylinder section connected to the first cylinder section,
wherein the first cylinder section is provided with internal threads screwed to the vaporizer, and
wherein the second cylinder section extends along one end of the first cylinder section away from the vaporizer.

18. The aerosol generation apparatus of claim 17, wherein the regulating valve is sleeved over the second cylinder section, and
wherein the second air inlet is provided in the second cylinder section.
